(19) United States
(12) Patent Application Publication
(10) Pub. No.: US 2022/0407693 A1
(43) Pub. Date: Dec. 22, 2022

(54) METHOD AND DEVICE FOR SECURE COMMUNICATION

(71) Applicant: SAUL TROEN, NEW YORK, NY (US)

(72) Inventor: Christopher Howell, Honolulu, HI (US)

(73) Assignee: SAUL TROEN, NEW YORK, NY (US)

(21) Appl. No.: 17/352,355

(22) Filed: Jun. 21, 2021

(51) Int. Cl. H04L 9/08

(52) U.S. Cl. CPC H04L 9/0877; H04L 9/0863; H04L 9/0894; H04L 9/0825

(57) ABSTRACT

A method and device are provided for secure internet communication between a computing device and a server. The method employs non-extractable data stored within the device for the generation of a pair of master encryption keys, and the secure, non-internet transfer of one of the pair of keys to the server. Thereafter, communications between the device and the server are encrypted with one-time keys, the one-time keys being themselves encrypted with the master keys. At no time are either of the master keys transmitted over the internet, and at no time are the master keys stored together in a single device.

### FIELD OF THE INVENTION

This invention relates to methods and devices for the securing of online communications from eavesdropping, and for preventing the hijacking of a channel of communication once it is opened. Fields of use include online financial transactions and the transmission of confidential information.

### BACKGROUND

The growth of individual and organizational access to the Internet in recent decades has made it an attractive conduit for the transfer of financial data, and in particular for conducting transfers of money in payment for goods and services, settlement of accounts, and meeting contractual obligations. E-commerce in 2020 amounted to $860 billion in the US alone, and the sums transferred world-wide are measured in trillions of dollars. Banks commonly offer their customers online access to account information and, increasingly, the ability to conduct online transactions, and Banking as a Service (BaaS) allows third parties that are not banks to offer banking products and services via online portals. Giving customers the conveniences of online banking often means giving unsophisticated users the ability to initiate money transfers from their computers and mobile devices, a situation that fraudsters, hackers, and cybercriminals are constantly trying to exploit. Defeating these malicious actors, while keeping online banking simple and convenient for customers, is an ongoing challenge for finance industry technologists.

Governments and corporations are also heavily invested in the Internet as a communications channel. As with financial institutions, there is a need to secure such communications against espionage, data theft, and other forms of malicious activity.

The average consumer makes most network connections over the air (OTA) via Wi-Fi, and to a lesser extent via ethernet, through a home or office router, with a browser serving as the user interface. Connection via cellular phone providers is becoming more common, as financial institutions roll out mobile apps to provide online services. Because OTA networks are susceptible to interception and copying of the signal, applications that run on mobile devices handle the security of the network connection and any data transmitted over it. This is generally not the case when a computer makes a connection via a browser.

Furthermore, ISPs and Wi-Fi access point providers commonly inspect and store network traffic, in order to monitor browsing and connection habits, and a data breach exposing this information could be exploited by cybercriminals. Finally, a malicious actor, equipped with simple hardware and readily available software, can stage “man in the middle” or “drive by” attacks that capture over-the-air data packets and redirect them to malicious sites.

For users of personal computers and browsers, virtual private networks (VPNs) enable secure, encrypted connections designed to ensure that traffic cannot be intercepted and that the user can operate anonymously. A VPN application establishes a secure connection between the browser and a remote VPN server or network point of presence (POP), and a second connection is established from that POP to the target web site. At the target, traffic appears to be coming from the POP, not the actual user, who remains invisible to any intermediary ISP or CSP. However, VPN client applications can be difficult for the average consumer to set up (and next-to-impossible to troubleshoot), the application needs to be activated to ensure that network activity is secure, and most VPN services charge a monthly or annual fee. Many banks block VPN server connections as a security measure at their own sites, and consumers generally must navigate or negotiate past that final roadblock as well.

Encryption, two-factor authentication, and combinations of the two are among the most common measures taken to make communications secure against malicious third parties, and it is common for banks and other financial service providers to build those protections into their online services and mobile applications. Such measures, while effective against most threats, can be still defeated by sophisticated government-sponsored hackers and top-tier cybercriminals. Most commonly, these actors use “social engineering” to concoct e-mail messages designed to convince the recipient that the message is from a trusted sender (a so-called “phishing” attack.). The recipient, being deceived in this way, can easily be induced to open an innocent-looking attachment that launches an executable file, to click on a url that contains code for DNS cache poisoning, or to open a web page that will exploit a browser vulnerability to load malware into the victim's computer.

Malware can be designed to do many things, including keylogging, finding and exporting passwords, keys, and other confidential information and files, downloading additional malware and spreading it through the victim's network, and encrypting the victim's files and holding them for ransom. A common goal for cybercriminals is to obtain admin-level privileges, which allows them to control and exploit a victim's entire network. The victim's computer and network can be exploited to serve a botnet, to mine cryptocurrency, or to conduct espionage against the network owner, or the access can be sold to other parties who have their own nefarious purposes.

Of growing concern is malware designed to wait for the victim to initiate a secure communication, and once all passwords, authentication factors, and encryption keys have been successfully deployed, hijack the secure link to execute fraudulent transactions before the victim realizes that anything is amiss. Falsified information may be displayed on the user's screen while the fraudulent transaction takes place in the background. Because the victim has taken all of the steps required to prove his identity as an authorized user, including having provided, e.g., a biometric, hardware, or one-time code second factor, the financial institution is unaware of the fraud taking place, making this form of attack very difficult to prevent.

Attacks that begin with social engineering are almost impossible to guard against, as it is difficult to educate all users of a network to the level of technical savvy needed to be constantly alert to threats. Even sophisticated users can be deceived by, e.g., an email that appears to be from their superior, demanding that an attached file be acted upon in some way. Consumer-level antivirus programs generally recognize only known malware, which means that they fail to block newly-released “zero day” exploits. More sophisticated security suites are designed to recognize and halt “suspicious” activities being executed by other programs, but false alarms are common, and they tend to impair a computer's performance. There remains a need for methods of authenticating users and securing communications that are resistant to advanced forms of malware.

### BRIEF DESCRIPTION OF THE INVENTION

Broadly, the invention provides a method of securely encrypting communications over the Internet between a user's computing device and a server. The user's computing device may be a desktop computer, laptop, tablet, or cellular phone. The method employs a trusted platform module (TPM), which generates an associated pair of master encryption keys. One of the master keys is securely transferred to the server, and the other is store by the TPM. A unique identifier, associated with the TPM, is also stored on the server. Upon initiation of communication between the computing device and the server, the TPM generates a one-time encryption key, which is then encrypted with the master key stored in the TPM. The message to be communicated is encrypted with one-time encryption key. What is then transmitted over the Internet is a communication comprising the unique identifier, the encrypted one-time encryption key, and the message encrypted with the one-time encryption key.

The server, upon receiving the communication, identifies the proper decryption key via the unique identifier, decrypts the one-time key, and with that, decrypts the message. A third party eavesdropper or hacker, regardless of the level of access he may have obtained, never has the opportunity to access either of the master keys, and thus cannot obtain the one-time key or read the transmitted message.

In one embodiment, the invention provides a specialized device, incorporating the TPM and capable of communicating with a user's smart card or other microchip-equipped hardware token. The term “card” will be used herein to refer to all such tokens, regardless of size or shape, whether contactless or not. The card may be, for example, an ATM, debit, credit, or stored value card, which encodes at minimum an encryption key or certificate, and an account number and/or a PIN code. The device of the invention may communicate with the card's on-board chip via electrical contacts or via contactless (NFC) communication means. In one embodiment, the card is required to be read at each transaction. In a second embodiment, the information on the card is written to memory within the device, so that the card needs to be read only upon the initialization of the device—in this embodiment, the device becomes a proxy for the card.

The term “bank” is used herein for convenience and ease of understanding, but should be understood to refer to any financial institution, including but not limited to banks, credit unions, brokerage houses, and BAAS providers. It should be understood, also, that the invention is useful for secure communications in non-financial fields, and that “bank” may be replaced by “government agency”, “military authority”, “corporate office”, or any other second party that the user of the device (the first party) wishes to securely communicate with, without departing from the scope of the invention.

The device has the ability to be synced with the bank's server. This process, referred to as “provisioning”, generates a master encryption key, locked to the devices internal TPM. The same key (for symmetric encryption) or a complimentary “public” key (for asymmetric encryption) is stored on the bank's server, and a unique identifier is created which locks the device to a specific user and his or her accounts. Optionally, the device may be locked to a single account, and the user may be assigned a separate device for each separate account.

The device sits between the user and his router, and upon detection of a communication with the financial institution, generates a request comprising a unique customer (or device) identifier, a newly-generated key (itself encrypted with the shared key), and the actual message, which has been encrypted with the newly-generated key. By generating a fresh key for each message, and encrypting it with the shared key, the present invention virtually eliminates the possibility of message decryption by a third party. By having the device registered to the user, the present invention eliminates the need to transmit the user's account, password, or other potentially exploitable information—only the unique identifier is transmitted in the clear.

The device containing the TPM and the user's computing device may be combined into a single device. For example, a board incorporating the TPM can be plugged into a PCI slot within a personal computer. In other embodiments, the TPM can be built onto the motherboard of a computer, or it can be an element of a system-on-chip such as an ARM processor. The TPM can also be built into a cellular telephone, which also serves as the user's computing device.

The financial institution has the appropriate “public” half of the shared key associated with the device, and can decrypt the newly-generated key, then decrypt the message, recognize the credentials, and only then perform the transactions requested by user. It is a characteristic of the present invention that the “public” key is not truly public, but is known only to the financial institution—and indeed it may not be “known” to any human at the institution. The keys may reside exclusively in electronic storage, in files that may be hidden to all but the highest-level administrators, and which may themselves be encrypted and/or unreadable by any single individual. The “private” key exists only within the TPM of the device, from which it cannot be read or extracted.

The entire system may be transparent to the user, particularly in the second embodiment, because the device itself is a second-factor authentication token. In the first embodiment, the system is even more secure because it requires the card as a third factor. Additional factors, e.g. entry of a PIN, or a biometric identifier such as a fingerprint reader or facial recognition unit, can optionally be required to authenticate the physical presence of an authorized user.

### BRIEF DESCRIPTION OF THE FIGURES

FIG. 1 is a block diagram showing the functional components of the invention.

### DETAILED DESCRIPTION OF THE INVENTION

The methods and devices of the invention create enhanced security by creating custom per user, per use encryption of electronic communications with a target institution, such as a bank, government agency, or other communicant that requires highly confidential and secure communication.

The invention provides a method of securely encrypting communications over the Internet between a computing device and a server, which employs the initial generation of an associated pair of master encryption keys by a device that incorporates a trusted platform module (TPM). A secure, non-internet method is used to transfer one of the master keys to a server, while the other of the master keys is stored in the TPM. A unique identifier associated with the particular TPM, which may be permanently embedded within the TPM or generated as needed, is also securely transferred to the server. When communication between the computing device and the server is initiated over a network such as the Internet, a one-time encryption key is generated by the TPM and encrypted with the master key stored in the TPM. The message to be communicated is then encrypted with this one-time encryption key. What is then communicated over the network to the server is data comprising the unique identifier, the one-time encryption key encrypted with the master key, and the message encrypted with the one-time encryption key. The server decrypts the one-time key using the master key associated with the unique identifier, and then uses the one-time key to decrypt the message.

The invention also provides a device for securely encrypting communication of a message over the Internet between a computing device and a server, comprising a trusted platform module (TPM), a central processing unit, non-volatile computer-readable memory, at least one Ethernet or wireless communication protocol controller, and at least one Ethernet or wireless transceiver. The TPM stores an identifier unique to the device, along with one of a pair of master encryption keys, the other of the pair being stored on the server. The non-volatile memory stores computer-readable instructions that, when executed, cause: (i) generation by the TPM of a one-time encryption key, (ii) encryption of the one-time encryption key with the master encryption key stored in the TPM, (iii) encryption of the message with the one-time encryption key, and (iv) transmission via the protocol controller of a communication comprising the unique identifier, the one-time encryption key encrypted with the master key, and the message encrypted with the one-time encryption key.

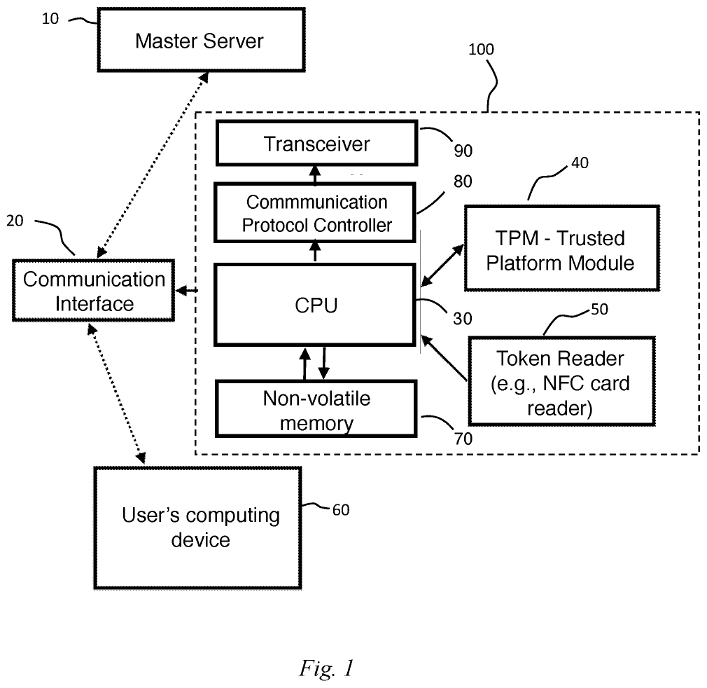

Referring to FIG. 1, in one embodiment of the invention the device of the invention (100) connects to communication interface (20), which can be, e.g., a standard Wi-Fi router or a public network connection. This connection can be wireless (e.g., Wi-Fi) or wired (e.g., Ethernet.) The user's computing device (60), which may be, e.g., a desktop or laptop computer, tablet, or mobile device, similarly connects to the interface (20), via a wireless or wired connection. When the user wishes to perform secure transactions with the institution associated with the device (100), such communications are routed through the device (100). In order to provide the user with complete flexibility of installation and use, device (100) preferably comprises a wireless protocol controller (80) for transmitting data to a wireless transceiver; and one or more wireless transceivers (90), as well as one or more Ethernet controllers and transceivers. The device further comprises a central processing unit (30), non-volatile memory (70) for storing instructions, a Trusted Platform Module (TPM) (40), and optionally, a token reader (50) which may be, as illustrated in this embodiment, an NFC card reader. Elements (30), (70), (80) and (90) are preferably incorporated into a single system-on-chip, or SOC.

In alternative embodiments, devices (100) and (60) are integrated elements of a cellular phone, tablet or laptop computer owned by the user, which is brought to the bank for provisioning with master encryption keys as described below. In these embodiments, in addition to Wi-Fi wireless communications with a router, cellular telephony data protocols such as 4G and 5G wireless can be employed to communicate with the server. A mobile banking application will be installed to serve as a user interface for communication with the bank's server using the secure methods of the invention. The mobile banking application may be a downloaded app specific to the bank, or it may be a generic, reinstalled application integrated with the phone's operating system. In other embodiments, certain aspects of the invention may be provided by the operating system, and made available to application developers.

Prior to first being used, the device (100) is provisioned by the Master Server (10). At this step, its internal trusted platform module (TPM) (40) generates a unique “master” encryption key, and sends it to the Master Server (10), where it is stored and assigned to a specific customer account, or assigned to a unique identifier that can later be assigned to a specific customer account. That “master” key is not stored on the device (100), but is only accessible for decryption by the master server (10) of messages encrypted by a corresponding “co-master” key stored in that particular device's TPM (40), and only when it is in communication with the Master Server (10). The master and co-master keys may be identical “long” keys, so that the device and server employ symmetrical encryption, or they may be a public and private key of conventional length, so that asymmetric encryption is used. It will be understood that the roles of “public” and “private” key may be interchanged in this embodiment, since neither key is actually made public. Although symmetric or asymmetric cryptography may be employed, asymmetric encryption is preferred, as a precaution against a breach of either the device or the institution's systems. The private half of an asymmetric pair of keys should preferably be stored on whichever system is considered more secure.

The above provisioning method solves the prior art problem of securely exchanging keys at the setup stage. The exchange is conducted locally, rather than over the Internet, so that there is little or no opportunity for interception by a malicious third party. The initial provisioning of the device 100 by the server 10 can be conducted over the bank's own secure (e.g. https) intranet, and in extremely high-security applications it may be done directly via a cabled (i.e., hardware interface) connection to the server, with no intervening network elements that could be exploited by an eavesdropper.

The level of security of communications provided by the present invention is extremely high because (1) the keys used to encrypt messages between the device and the server are one-time keys, (2) the one-time keys are themselves encrypted with the master keys, and (3) one of the master keys is created within and stored within the TPM (40), and is never transmitted by any method to any recipient, while the other can be transferred to and stored on the master server (10) with the highest security protocols available to the bank.

The TPM (40) is a cryptoprocessor that preferably complies with current standards, such as, at present, ISO/IEC 11889. The TPM accordingly comprises a persistent memory storing an endorsement key and a storage root key, a versatile memory storing platform configuration registers, attestation identity keys, and storage keys, and a cryptographic processor that incorporates a random number generator, an RSA key generator, and a hash generator (e.g. SHA-1). The processor also provides the necessary encryption/decryption signature engine. Together, these elements allow the TPM to provide a unique identity to the device. The stored master key may be non-extractably stored within the TPM, or it may be constructed so as to be non-functional in the absence of unique, non-extractable data built into the TPM. The use of non-extractable, unique device identifiers in encryption is a known technique, described for example in U.S. Pat. No. 8,788,842, the entire contents of which are incorporated herein by reference.

The device (100) may be subsequently initialized by contact of the NFC card reader (50) with an NFC-enabled smart card associated with the same specific customer account. The embodiment shown in FIG. 1 employs wireless communication with an NFC reader, but it will be understood that a contact reader can be employed in an equivalent manner. When the user wishes to perform a secure transaction, the device sends a message to the server that comprises at least
(1) the user's unique identifier, as assigned by the server,
(2) a newly-generated encryption key, which has itself been encrypted with the key stored in the TPM, and
(3) the message itself, encrypted with the newly-generated key.

When the server receives a message it looks up the unique identifier, finds the appropriate master key for that user, decodes the newly generated key, and decodes the message using that key. A similar process happens when the server wishes to respond to a user's request: a message is sent to the user consisting of (1) a newly generated key, encrypted with that user's master key, followed by (2) the response message, encrypted with the newly-generated key. The device (100) decodes the new key by utilizing the TPM, never transmitting and thus fully protecting the master key. In an alternative embodiment, the response can employ the same one-time key as the initial message; effectively it becomes a “two-time” key. This embodiment reduces the calculation overhead with minimal risk to the security of the communications.

Two factor authentication is provided by the device (100) itself, which is effectively a hardware token, and this can be augmented if desired by requiring input of a PIN number, and/or input from the card reader (prompting the user to scan the associated card), in order to finally approve the transaction. The card, in this embodiment, serves as an additional 2FA hardware token. In alternative embodiments, input from other forms of hardware token may be required to approve the transaction. The hardware token may be programmed with functions such as the token's cryptographic key, whether a PIN is required, and token password generation based on internal clock timing or user PIN input. The token may be assigned to the user by linking its serial number to the user's record, stored in an authentication system database. The token may operate in time synchronous, event synchronous, or challenge-response (asynchronous) mode. The token may also be a passive token, with a certificate that, when detected, merely indicates the physical presence of the token.

In these alternative embodiments, the card reader may be replaced by a USB port, numeric keypad, or other interface appropriate to the type of input required. In other embodiments, biometric user identification, such as fingerprint or facial recognition, may be employed as a second factor.

In certain embodiments, the requirement for any of the above forms of augmented security can be triggered by the size or nature of the transaction.

All of the above-described operations can be carried out by a single programmable system-on-chip (SOC) (30) within device (100), provisioned with the stored information and services of TPM (40). Device (100) can be powered by a replaceable battery, rechargeable built-in battery, and/or an external source of DC voltage, as are commonly used in portable electronic devices.

The device (100) preferably monitors its startup sequence to prevent hacking of the device itself. In certain embodiments, the device may be configured to erase the master key if a hacking attempt is detected. This further guarantees the security of the links it provides, ensuring that its own master key remains secret.

In certain embodiments, the device (100) can limit network access to known, registered, devices (60). New devices, recognized for example by their MAC addresses, can be registered by the end user, with the registrations being validated by scanning the associated bank card.

There are a number of non-banking applications for the device and methods of the invention. A smart identity card or NFC token can serve as a security key, instead of an associated bank card, to establish secure communications with a master server for any purpose, including for example messaging, server or network access, file transfers, and remote command and control.

The device is useful for any application in which a secure communication between an assigned server and a remote user is desired, and requires only that it be possible to previously set up matching credentials on the server (10) and the device (100). This initial provisioning is preferably accomplished by direct physical connection between the device (100) and master server (10), to avoid possible interception of the master key during the setup process. A bank, for example, can pre-provision many such devices, and subsequently assign them to customers, and associate them with customer accounts, as needed.

For the educational market, the device can provide verification of a student's identity, and allow for secure remote teaching and testing. Online access to copyrighted materials can be limited to authorized students who have made the required tuition payments, and copyright income can be fairly allocated to authors and publishers on the basis of actual access and use of their intellectual property.

For the government market, the device could provide secure voting services, possibly as a stand-alone device, where the user activates a pre-authorized device with a near-field chip contained in their voter registration card or driver's license. Diplomatic and military personnel, of course, can benefit from the highly secure communications that the device provides.

For the legal and corporate markets, the device can enable secure, instant sharing of project assets among authorized members of a team, allowing collaboration from remote locations without fear of interception or espionage.

The illustrations provided in the drawings, and descriptions provided by this specification, are intended as representative examples; accordingly the invention is not limited to the described and/or illustrated embodiments. Those of skill in the art can readily envision obvious equivalents and alternatives to the specific embodiments of the invention described herein, and such obvious equivalents and alternatives are contemplated by the inventor to be embodiments of the present invention. No disclaimer of any such equivalents and alternatives, explicit or implied, is intended to be made by the present disclosure or by the drawings. The scope of the claims appended hereto should, accordingly, be understood to encompass any and all such equivalents and alternatives.

I claim:

1. A method of securely encrypting communications over the Internet between a computing device and a server, comprising:
(a) generation of an associated pair of master encryption keys by a trusted platform module (TPM);
(b) secure, non-internet transfer of a first of the master encryption keys to a server, which stores the transferred key in association with a unique identifier associated with the TPM;
(c) storage of the second of the master encryption keys in the TPM;
(d) upon initiation of communication between the computing device and the server, generation by the TPM of a one-time encryption key;
(e) encryption of the one-time encryption key with the master encryption key stored in the TPM;
(f) encryption of a message with one-time encryption key;
(g) transmission over the Internet of a communication comprising the unique identifier, the one-time encryption key encrypted with the master key, and the message encrypted with the one-time encryption key.

2. The method according to claim 1, further comprising associating, on the server, the unique identifier with a customer account identifier.

3. The method according to claim 1, wherein the transmission at step (g) is contingent upon the TPM detecting the presence of a second factor authorization token.

4. The method according to claim 1, wherein the TPM and the computing device are separate devices.

5. The method according to claim 1, wherein the computing device comprises the TPM.

6. The method of claim 5, wherein the computing device is a cellular phone.

7. The method of claim 5, wherein the computing device is a personal computer.

8. A device for securely encrypting communication of a message over the Internet between a computing device and a server, comprising a trusted platform module (TPM), a central processing unit, non-volatile computer-readable memory, at least one Ethernet or wireless communication protocol controller, and at least one Ethernet or wireless transceiver, wherein
(a) the TPM stores an identifier unique to the device;
(b) the TPM stores one of a pair of master encryption keys, the other of the pair being stored on the server; and
(c) the non-volatile memory stores computer-readable instructions that, when executed, cause:
(i) generation by the TPM of a one-time encryption key,
(ii) encryption of the one-time encryption key with the master encryption key stored in the TPM,
(iii) encryption of the message with the one-time encryption key, and
(iv) transmission to the server, via the protocol controller, of a communication comprising the unique identifier, the one-time encryption key encrypted with the master key, and the message encrypted with the one-time encryption key.
